(19) United States
(12) Patent Application Publication
(10) Pub. No.: US 2014/0272913 A1
(43) Pub. Date: Sep. 18, 2014

(54) METHODS AND APPARATUS FOR EFFICIENT LEARNING

(71) Applicant: APEXLEARN LTD., Taipei City (TW)

(72) Inventors: Yenyu Chen, Taipei City (TW); Borching Su, New Taipei City (TW); Yun Long, Taipei City (TW)

(73) Assignee: APEXLEARN LTD., Taipei City (TW)

(21) Appl. No.: 14/213,007

(22) Filed: Mar. 14, 2014

Related U.S. Application Data
(60) Provisional application No. 61/782,699, filed on Mar. 14, 2013.

(51) Int. Cl. G09B 7/00

(52) U.S. Cl. CPC G09B 7/00
USPC 434/362

(57) ABSTRACT

A learning support method is provided. First, an n-th review of each of a plurality of learned items is provided, and the n-th review comprises at least one question. Then, an (n+1)-th review of each of the plurality of learned items is provided after a period of time determined based on an n-th memory strength of each of the plurality of learned items and a memory retention threshold. The n-th memory strength of each of the plurality of learned items is determined based on answer time and an answer to each of the at least one question.

### CROSS REFERENCE TO RELATED APPLICATIONS

This Application claims priority of U.S. Provisional Application No. 61/782,699, filed on Mar. 14, 2013, the entirety of which is incorporated by reference herein.

### BACKGROUND OF THE INVENTION

1. Field of the Invention

The invention generally relates to a learning support apparatus and a learning support method, and more particularly, to a learning support apparatus and a learning support method for scheduling reviews of learned materials based on an appropriate schedule.

2. Description of the Related Art

Traditionally, reviews of learned materials are required for a learner to improve retention, especially in learning vocabulary. If the learned materials are not reviewed by the learner, the memory retention of the learned materials will decay over time. However, if the reviews are not scheduled appropriately, the load of making the reviews will increase massively as the learned materials increase. For example, in a case where the learner who is learning a foreign language learns 10 new words and reviews learned words every day, on the first day, the user will learn 10 new words, on the second day, the user will learn 10 other new words and have 10 words to be reviewed, and on the tenth day, the user will learn 10 other new words and have 90 words to be reviewed. At this rate, the load of reviewing learned words will soon become too heavy to be taken after, for example, a month. Therefore, a learning support method and a learning support apparatus for managing reviews of learned materials based on an appropriate schedule are needed.

### BRIEF SUMMARY OF THE INVENTION

Accordingly, the invention provides a learning support method, a learning support apparatus and a non-transitory computer-readable medium encoded with computer executable instructions for performing the learning support method to provide reviews of learned items based on a schedule determined according to a learner's learning status so as to improve the learner's learning efficiency.

An embodiment of the invention provides a learning support method, comprising: providing an n-th review of each of a plurality of learned items, wherein n is a positive integer, and the n-th review comprises at least one question; determining an n-th memory strength of each of the plurality of learned items based on answer time and an answer to each of the at least one question; and providing an (n+1)-th review of each of the plurality of learned items after a period of time determined based on the n-th memory strength of each of the plurality of learned items and a memory retention threshold.

Another embodiment of the invention provides a learning support apparatus, comprising a memory device, at least one output device and a processor. The memory device stores a plurality of learned items. The at least one output device provides an n-th review of each of the plurality of learned items and an (n+1)-th review of each of the plurality of learned items after a period of time from the n-th review, wherein n is a positive integer. The n-th review comprises at least one question. The processor determines an n-th memory strength of each of the plurality of learned items based on answer time and an answer to each of the at least one question and determines the period of time based on the n-th memory strength of each of the plurality of learned items and a memory retention threshold.

Still another embodiment of the invention provides non-transitory computer-readable storage medium encoded with computer-executable instructions that, when executed, cause an electronic apparatus to perform a learning support method. The learning support method comprises: providing an n-th review of each of a plurality of learned items, wherein n is a positive integer, and the n-th review comprises at least one question; determining an n-th memory strength of each of the plurality of learned items based on answer time and an answer to each of the at least one question; and providing an (n+1)-th review of each of the plurality of learned items after a period of time determined based on the n-th memory strength of each of the plurality of learned items and a memory retention threshold.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 illustrates a block diagram showing a relationship between memory retention of a learned item and time;

FIG. 2 illustrates a flowchart of a learning support method according to an embodiment of the invention;

FIG. 3A and FIG. 3B illustrate block diagrams of a review of a learned item according to an embodiment of the invention;

FIG. 4 illustrates a flowchart of a learning support method according to an embodiment of the invention;

FIG. 5 illustrates a block diagram of an exemplary arrangement of reviews of a learned item according to an embodiment of the invention;

FIG. 6 illustrates a block diagram of a learning support apparatus according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

It is to be understood that the following disclosure provides many different embodiments, or examples, for implementing different features of the application. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. The scope of the invention is best determined by reference to the appended claims.

FIG. 1 illustrates a block diagram showing a relationship between memory retention of a learned item and time. As shown in FIG. 1, the memory retention of the learned item decays exponentially over time. For example, the memory retention P of the learned item over time t is determined based on P=e^{-t/s}, wherein e is the natural number and S is a memory strength representing a decay rate of the memory retention. If the memory retention of the learned item decays below a memory retention threshold R, the learner may hardly remember the learned item anymore. On the other hand, if the learner makes a review of the learned item before the memory retention of the learned item decays below the memory retention threshold R, the memory retention of the learned item will increase significantly and decay more slowly after the review.

A learning support method for efficiently scheduling reviews of learned items will be explained with reference to FIG. 2˜FIG. 5 in the following.

FIG. 2 illustrates a flowchart of a learning support method 20 according to an embodiment of the invention. In step S210, an n-th review of a learned item is provided. In the invention, n is a positive integer. The n-th review of the learned item comprises at least one question. Then, in step S220, an n-th memory strength S(n) of the learned item is determined based on answer time t and an answer to each of the at least one question of the n-th review. In step S230, an (n+1)-th review of the learned item is provided after a period of time T(n) determined based on the n-th memory strength S(n) and the memory retention threshold R. That is, the time interval between the n-th review and the (n+1)-th review of the learned item is the period of time T(n). The higher the n-th memory strength is, the longer the period of time T(n) is. In an embodiment, if the answer to each of the at least one question of the n-th review is correct, the n-th memory strength S(n) is determined based on S(n)=A(t)×S(n−1). A(t) is a function of the answer time t, and the value of A(t) increases as the value of t decreases. In an example, the value of A(t) ranges from 1.5 to 5.

FIG. 3A and FIG. 3B illustrate block diagrams of an n-th review of a learned item according to an embodiment of the invention. The n-th review comprises a first question and a second question. The first question is whether to answer the second question and provided before the second question, and the second question regards the learned item.

In the example shown in FIG. 3A and FIG. 3B, the vocabulary ‘vision’ is the learned item. In the n-th review of the learned item ‘vision’, firstly a window 31 showing the first question is displayed on a display device. As shown in FIG. 3A, part of content of the learned item ‘vision’, such as spelling, pronunciation and an image, is provided in the first question. The user has to determine whether to answer the second question of the learned item ‘vision’. For example, after seeing the part of content of the learned item ‘vision’, the user clicks the “Answer” button, and then a first answer time t1 and a first answer Ans1 are determined. The first answer time t1 represents how fast the user can recall the learned item.

After the user clicks the “Answer” button on the window 31, a window 32 showing the second question regarding the learned item ‘vision’ is displayed on the display device. For example, the second question is about the meaning of the learned item ‘vision’. Once the user answers the second question by clicking an option and then clicking the “Next” button, a second answer time t2 and a second answer Ans2 are determined.

FIG. 4 illustrates a flowchart of a learning support method 40 according to an embodiment of the invention. In step S410, n is set to 1. In step S420, an n-th review of a learned item is provided. The n-th review comprises a first question and a second question. As described above, the first question is whether to answer the second question and part of content of the learned item is provided in the first question. The second question regards the learned item and is provided after the first question. Once the first question is answered, a first answer time t1 and a first answer Ans1 to the first question are determined. Moreover, once the second question is answered, a second answer time t2 and a second answer Ans2 to the second question are determined. The first answer time t1 is the period of time the user spends to answer the first question of the n-th review and the first answer Ans1 is the answer which the user makes to the first question. The second answer time t2 is the period of time the user spends to answer the second question in the n-the review and the second answer Ans2 is the answer which the user makes to the second question.

In step S430, it is determined whether the first answer Ans1 is yes. If the first answer Ans1 is no (S430: No), that is, the second question is not to be answered, the learning support method 40 proceeds to step S450. As shown in step S450, the memory retention P of the learned item is set to a predetermined value, for example, 0. If the first answer Ans1 is yes (S430: Yes), that is, the second question is to be answered, the learning support method 40 proceeds to step S440. In step S440, it is determined whether the second answer Ans2 to the second question is correct. If the second answer Ans2 is correct (step S440: Yes), the learning support method 40 proceeds to step S460. As shown in step S460, the n-th memory strength S(n) of the learned item is determined based on S(n)=A(t1, t2)×S(n−1). On the other hand, if the second answer Ans2 is incorrect (step S440: No), the learning support method 40 proceeds to step S450 and the memory retention P of the learned item is set to the predetermined value.

After the n-th memory strength S(n) of the learned item is determined, in step S470, a period of time T(n) is determined based on

$$T ( n ) = S ( n ) \times ln ( \frac{1}{R} ) ,$$

wherein R is the memory retention threshold. In step S480, an (n+1)-th review of the learned item is provided after the period of time T(n), that is, the time interval between the n-th review and the (n+1)-th review of the learned item is the period of time T(n). After that, as shown in step S490, n is set to n+1 and then the learning support method 40 proceeds back to step S420. The steps in the learning support method 40 are applied to each of a plurality of learned items.

As described above, if the first answer Ans1 is yes and the second answer

Ans2 is correct, the n-th memory strength S(n) of the learned item is determined based on S(n)=A(t1, t2)×S(n−1). A(t1, t2) is a function of the first answer time t1 and the second answer time t2. The value of A(t1, t2) increases as the values of t1 and t2 decrease. Moreover, the value of A(t1, t2) is more sensitive to the value of the first answer time t1 than to the value of the second answer time t2. In an example, the value of A(t1, t2) ranges from 1.5 to 5.

As described above, if the first answer Ans1 is no, or, if the first answer Ans1 is yes and the second answer Ans2 is incorrect, the memory retention P is set to the predetermined value. In addition, if the first answer Ans1 is yes and the second answer Ans2 is correct, the memory retention P is determined based on the n-th memory strength S(n) and time passing by after the n-th review, for example,

$$P = {e}^{- \frac{t ( n )}{S ( n )}} ,$$

wherein t(n) is the time passing by after the n-th review. In one embodiment, the (n+1)-th review is provided if the memory retention P is within a predetermined range, for example, [0.25, 0.9].

FIG. 5 illustrates a block diagram of an exemplary arrangement of reviews of a learned item according to the learning support method in FIG. 4. As shown in FIG. 5, the first review of the learned item is provided at time 0. After the period of time T(1), the memory retention of the learned item approaches the memory retention threshold R and the second review of the learned is provided. After the period of time T(2) from the second review, the memory retention of the learned item approaches the memory retention threshold R and the third review of the learned item is provided. As shown in FIG. 5, the reviews are scheduled efficiently without being provided too early or late.

In one embodiment, an item can be added into the plurality of learned items after a teaching material of the item is provided to the user. When the item is added into the plurality of learned items, reviews of the item are scheduled based on the learning support method described above. An initial memory strength S(0) of a newly-added learned item may be pre-determined based on

$$S ( 0 ) = \frac{t 0}{ln ( 1 / R )} ,$$

wherein t0 is an inter-study interval. For example, t0 may be pre-set to 1 day. In one example, a first review of the newly-added learned item may be provided after

$$T ( 0 ) = S ( 0 ) \times ln ( \frac{1}{R} )$$

from the learned item's being added into the plurality of learned items. In one embodiment, if the n-th review of the learned item is failed, for example, if the first question is no or the second question is incorrect, the item is eliminated from the plurality of learned items, and a teaching material of the item may be provided after the item is eliminated from the plurality of learned items.

In one embodiment, a plurality of items is first provided, such as by the display device, to the user. Then the user may determine whether each of the plurality of items has been learned. If it is determined that an item has been learned, the item is added into the plurality of learned items.

In one embodiment, a test is provided to the user before the learning support method described above is performed. The test regards a plurality of items sorted based on difficulties. Based on the result of the test, the user's capability is determined. Items of the plurality of items that have difficulties not higher than the user's capability are added into the plurality of learned items and initial memory strengths R(0) of the items may vary from difficulty to difficulty. For example, the initial memory strengths R(0) of the items whose difficulties are equal to the user's capability are set to a predetermined value, and the less the difficulty is, the larger the initial memory strength R(0) is.

Regarding the memory retention threshold R, in one embodiment, the memory retention threshold R is a predetermined value, for example, 0.9. In another embodiment, the memory retention threshold R is dynamically determined based on a learning deadline. For example, when there is still two months before the learning deadline, such as an examination date, the memory retention threshold R is 0.9. The retention threshold R increases as the learning deadline approaches. Then, when there is only 1 week before the learning deadline, the memory retention threshold R is 0.99. In view of this, memory retention of all learned items may remain not less than 0.99 at the learning deadline.

Though there is one second question in a review as described above, the invention is not limited thereto. Each review may comprise a first question and a plurality of second questions. In an embodiment, the learning support method 40 will proceed to step S460 if answers to the plurality of second questions are all correct. In another embodiment, the n-th memory strength S(n) will be determined to be S(n-x) if at least one answer to the plurality of second questions is incorrect, wherein x is a positive integer less than n and may vary with the number of incorrect answers, and the memory retention will be set to the predetermined value if answers to the plurality of second questions are all incorrect. The second question may be a multiple-selection question.

In one embodiment, the part of content of the learned item provided in the first question may vary from review to review. For example, the spelling of ‘vision’ is provided in the first question of the first review and the pronunciation of ‘vision’ is provided in the first question of the second review.

In one embodiment, the second question(s) in the (n+1)-th review may regard to the same aspect of the learned item as the second question(s) in the n-th review. For example, the second questions in the n-th review and the (n+1)-th review all regard the spelling, pronunciation or meaning of the learned item ‘vision’. Furthermore, there may be a plurality of n-th memory strengths for one learned item, each of which regards to different aspect of the learned item. For example, the learned item ‘vision’ have an n-th memory strength for spelling, an n-th memory strength for pronunciation and an n-th memory strength for meaning In this case, reviews for different aspects of the learned item may be scheduled independently. In another embodiment, each of the second questions in the n-th review may regard different aspect of the learned item. In this case, the n-th memory strength of the learned item represents combined memory strength for aspects of the learned item.

In one embodiment, if a series of reviews are failed (that is, the first answer is no or the second answers are all incorrect), reviews of learned items with memory retention above 0.9 are provided to maintain the user's confidence about learning and keep the user's interest in learning. In one example, a teaching material may be provided based on the estimated memory retention. For example, an article in which most of words has memory retention not smaller than 0.9 is provided to the user.

In one embodiment, the period of time T(n) may be further adjusted based on a predefined schedule. In a case where reviews of learned items are scheduled to be made every Tuesday and Friday, if an (n+1)-th review of a learned item is supposed to be provided on Wednesday based on the determined period of time T(n), the determined period of time T(n) is adjusted (shortened) such that the (n+1)-th review of the learned item can be provided on Tuesday.

FIG. 6 illustrates a block diagram of a learning support apparatus 60 according to an embodiment of the invention. The learning support apparatus 60 comprises a memory device 610, a processor 620, a display device 630, an acoustic output device 640 and an acoustic input device 650. The memory device 610 stores the plurality of learned items. At least one output device, that is, the display device 630 or/and the acoustic output device 640, provide the scheduled reviews. For example, the display device 630 and the acoustic output device 640 provides an n-th review of each of the plurality of learned items and an (n+1)-th review of each of the plurality of learned items after a period of time T(n) from the n-th review. At least one input device, such as the acoustic input device 650 or/and a keyboard (not shown), is used to receive the user's response to the reviews. The processor 620 performs the learning support method described above. For examples, the processor 620 determines the n-th memory strength S(n), the period of time T(n), the memory retention P and the memory retention threshold R as described above.

In one embodiment, the display device 630 or/and the acoustic output device 640 provides a test regarding a plurality of items, the processor 620 determines the user's capability based on the result of the test and adds items of the plurality of items that have difficulties not higher than the user capability into the plurality of learned items stored in the memory device 610. the display device 630 or/and the acoustic output device 640 provides teaching materials of items of the plurality of items that have difficulties higher than the user capability.

Methods and systems of the present disclosure, or certain aspects or portions of embodiments thereof, may take the form of a program code (i.e., instructions) embodied in media, such as floppy diskettes, CD-ROMS, hard drives, firmware, or any other non-transitory machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

An embodiment of the invention provides a non-transitory computer-readable storage medium encoded with computer-executable instructions that, when executed, cause an electronic apparatus to perform the learning support method described above.

While the invention has been described by way of example and in terms of preferred embodiments, it is to be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A learning support method, comprising:
providing an n-th review of each of a plurality of learned items, wherein n is a positive integer, and the n-th review comprises at least one question;
determining an n-th memory strength of each of the plurality of learned items based on answer time and an answer to each of the at least one question; and
providing an (n+1)-th review of each of the plurality of learned items after a period of time determined based on the n-th memory strength of each of the plurality of learned items and a memory retention threshold.

2. The learning support method as claimed in claim 1, wherein the higher the n-th memory strength is, the longer the period of time is.

3. The learning support method as claimed in claim 2, further comprising:
if the answer is correct, determining the n-th memory strength S(n) based on S(n)=A(t)×S(n−1), wherein t is the answer time, and the value of A(t) increases as the value oft decreases.

4. The learning support method as claimed in claim 1, further comprising:
providing a test regarding a plurality of items;
determining a user capability according to result of the test;
adding first items of the plurality of items that have difficulties not higher than the user capability into the plurality of learned items; and
providing teaching materials of second items of the plurality of items that have difficulties higher than the user capability.

5. The learning support method as claimed in claim 4, wherein the lower a difficulty of a first item is, the higher initial memory strength of the first item is.

6. The learning support method as claimed in claim 1, further comprising:
increasing the memory retention threshold as a learning deadline approaches.

7. The learning support method as claimed in claim 1, wherein the at least one question comprises a first question and at least one second question, and the first question is whether to answer the at least one second question.

8. The learning support method as claimed in claim 7, further comprising:
if a first answer to the first question is yes and a second answer to each of the at least one second question is correct, determining the n-th memory strength S(n) based on S(n)=A(t1, t2)×S(n−1), wherein t1 is a first answer time to the first question, t2 is a second answer time to each of the at least one second question, and the value of A(t1, t2) increases as the values of t1 and t2 decrease.

9. The learning support method as claimed in claim 8, further comprising:
if the first answer is no, or, if the first answer is yes and the second answer is incorrect, setting a memory retention to a predetermined value;
if the first answer is yes and the second answer is correct, determining the memory retention based on the n-th memory strength S(n) and time passing by after the n-th review; and
providing the (n+1)-th review if the memory retention is within a predetermined range.

10. The learning support method as claimed in claim 8, wherein the value of A(t1, t2) is more sensitive to the value of t1 than to the value of t2.

11. The learning support method as claimed in claim 8, wherein at least one second question of the (n+1)-th review regards the same aspect of each of the plurality of learned items as the at least one second question of the n-th review.

12. The learning support method as claimed in claim 8, wherein the at least one second question of the n-th review comprises questions each of which regards different aspect of each of the plurality of learned items.

13. A learning support apparatus, comprising:
a memory device, storing a plurality of learned items;
at least one output device, providing an n-th review of each of the plurality of learned items and an (n+1)-th review of each of the plurality of learned items after a period of time from the n-th review, wherein n is a positive integer, and the n-th review comprises at least one question; and
a processor, determining an n-th memory strength of each of the plurality of learned items based on answer time and an answer to each of the at least one question, and determining the period of time based on the n-th memory strength of each of the plurality of learned items and a memory retention threshold.

14. The learning support apparatus as claimed in claim 13, wherein the higher the n-th memory strength is, the longer the period of time is.

15. The learning support apparatus as claimed in claim 14, wherein if the answer is correct, the processor determines the n-th memory strength S(n) based on S(n)=A(t)×S(n−1), wherein t is the answer time, and the value of A(t) increases as the value oft decreases.

16. The learning support apparatus as claimed in claim 13, wherein the at least one output device further provides a test regarding a plurality of items, the processor further determines a user capability according to result of the test and adds first items of the plurality of items that have difficulties not higher than the user capability into the plurality of learned items, and the at least one output device further provides teaching materials of second items of the plurality of items that have difficulties higher than the user capability.

17. The learning support apparatus as claimed in claim 13, wherein the lower a difficulty of a first item is, the higher initial memory strength of the first item is.

18. The learning support apparatus as claimed in claim 13, wherein the processor further increases the memory retention threshold as a learning deadline approaches.

19. The learning support apparatus as claimed in claim 11, wherein the at least one question comprises a first question and at least one second question, and the first question is whether to answer the at least one second question.

20. The learning support apparatus as claimed in claim 19, wherein if a first answer to the first question is yes and a second answer to each of the at least one second question is correct, the processor determines the n-th memory strength S(n) based on S(n)=A(t1, t2)×S(n−1), wherein t1 is a first answer time to the first question, t2 is a second answer time to each of the at least one second question, and the value of A(t1, t2) increases as the values of t1 and t2 decrease.

21. The learning support apparatus as claimed in claim 20, wherein
if the first answer is no, or, if the first answer is yes and the second answer is incorrect, the processor sets a memory retention to a predetermined value,
if the first answer is yes and the second answer is correct, the processor determines the memory retention based on the n-th memory strength S(n) and time passing by after the n-th review, and
wherein the at least one output device provides the (n+1)-th review if the memory retention is within a predetermined range.

22. The learning support apparatus as claimed in claim 20, wherein the value of A(t1, t2) is more sensitive to the value of t1 than to the value of t2.

23. The learning support apparatus as claimed in claim 20, wherein at least one second question of the (n+1)-th review regards the same aspect of each of the plurality of learned items as the at least one second question of the n-th review.

24. The learning support apparatus as claimed in claim 20, wherein the at least one second question of the n-th review comprises questions each of which regards different aspect of each of the plurality of learned items.

25. A non-transitory computer-readable storage medium encoded with computer-executable instructions that, when executed, cause an electronic apparatus to perform a learning support method, wherein the learning support method comprises:
providing an n-th review of each of a plurality of learned items, wherein n is a positive integer, and the n-th review comprises at least one question;
determining an n-th memory strength of each of the plurality of learned items based on answer time and an answer to each of the at least one question; and
providing an (n+1)-th review of each of the plurality of learned items after a period of time determined based on the n-th memory strength of each of the plurality of learned items and a memory retention threshold.

26. The non-transitory computer-readable storage medium as claimed in claim 25, wherein the higher the n-th memory strength is, the longer the period of time is.

27. The non-transitory computer-readable storage medium as claimed in claim 26, wherein the learning support method further comprises:
if the answer is correct, determining the n-th memory strength S(n) based on S(n)=A(t)×S(n−1), wherein t is the answer time, and the value of A(t) increases as the value oft decreases.

28. The non-transitory computer-readable storage medium as claimed in claim 25, wherein the learning support method further comprises:
providing a test regarding a plurality of items;
determining a user capability according to result of the test;
adding first items of the plurality of items that have difficulties not higher than the user capability into the plurality of learned items; and
providing teaching materials of second items of the plurality of items that have difficulties higher than the user capability.

29. The non-transitory computer-readable storage medium as claimed in claim 28, wherein the lower a difficulty of a first item is, the higher initial memory strength of the first item is.

30. The non-transitory computer-readable storage medium as claimed in claim 25, wherein the learning support method further comprises:
increasing the memory retention threshold as a learning deadline approaches.
